(19) United States
(12) Patent Application Publication
(10) Pub. No.: US 2008/0291321 A1
(43) Pub. Date: Nov. 27, 2008

(54) IMAGING APPARATUS

(76) Inventors: Kenichi Maruyama, Aichi (JP); Hiroshi Yamakose, Gifu (JP)

Correspondence Address: OSTROLENK FABER GERB & SOFFEN, 1180 AVENUE OF THE AMERICAS, NEW YORK, NY, 100368403, US

(21) Appl. No.: 12/118,300

(22) Filed: May 9, 2008

(30) Foreign Application Priority Data
May 23, 2007 (JP) 2007-136780

(51) Int. Cl. H04N 5/225

(52) U.S. Cl. 348/373; 348/E05.024

(57) ABSTRACT

In the presentation apparatus, an imaging subject is placed on the table, and the imaging subject is imaged by a video camera for presentation on the display of a computer or the like. The table includes a fastening member to which a camera support member fastens, and deploying panels which are pivotably supported at the sides of the fastening member. A deployment mechanism includes link members which at a first end thereof are respectively pivotably connected to the deploying panels and at the other end thereof are connected to one another by a connecting pin; a guide member for guiding the movement of the connecting pin; and a damper portion for applying resistance to movement of the connecting pin.

This application claims the benefit of and priority from Japanese Application No. 2007-136780 filed May 23, 2007, the content of which is incorporated herein by reference.

### BACKGROUND OF THE INVENTION

1. Field of the Invention

The present invention relates to an imaging apparatus in which an imaging subject is placed on a foldably stowed table on which it is imaged with a video camera.

2. Description of the Related Art

Conventionally known imaging apparatuses of this kind include presentation apparatuses for imaging documents and displaying them on a monitor display or the like, described in JP 2005-204010 A1. In order to facilitate imaging of documents, photographs, and the like, such an imaging apparatus is provided with a table for positioning of the document, and the video camera is held by a support post so that the camera faces the table. The table has a design enabling it to be folded by swivelable deploying panels which are pivotably pivoted to either side of a fastener member, making it easy to stow and transport. However, since the deploying panels of the table deploys through gravity acting, loud impact noise may occur when the deploying panels strike the placement stage, and may cause annoyance in some instances.

### SUMMARY

An advantage of some aspects of the invention is to provide an imaging apparatus in which the folded table can be deployed in an agreeable manner.

According to an aspect of the invention to provide with an imaging apparatus comprising: a foldably stowed table for positioning of an imaging subject; a video camera imaging the imaging subject on the table; a camera support member for holding the video camera; and a deployment mechanism for deploying the folded table and for stowing the deployed table. The table includes: a fastening member fastening the camera support member; and deploying panels respectively pivotably supported at the sides of the fastening member. The deployment mechanism includes link members having a first end and second end respectively, the first ends pivotably connected to the deploying panels respectively, the second ends connected to one another through a connecting pin, a guide member for guiding the movement of the connecting pin, and a damper portion for applying resistance to movement of the connecting pin.

In the imaging apparatus of the present invention, an imaging subject is positioned on the table, and the imaging subject is then imaged by the video camera and presented on a computer display or the like. In this way it will be possible to make a presentation in which an original which has been placed on the table is described, at the same time that the original is presented on the display. For transport, the table can be folded up making it easy to carry, while at times of service it may be deployed through the deployment mechanism thereby providing a large surface on which to position the imaging subject.

The table includes deploying panels which are respectively pivotably fastened to the sides of the fastening member to which the camera support member fastens, with the speed at which they are deployed by the deployment mechanism being controlled to a speed slower than that which would occur due to gravity. Specifically, the design of the deployment mechanism entails pivotably connecting the link members at a first end to either side of the fastener member while connecting them to one another at their other end; guiding the movement of the connecting pin through a guide member; and applying resistance to movement of the connecting pin through a damper portion. Specifically, since the deploying panels are exposed to resisting force from the damper portion via the link mechanism, they will deploy at a slower rate of speed than in the case of spontaneous descent, thereby preventing impact noise or damage when striking against the placement stage and deploying with an agreeably soft touch.

Moreover, the two link members at a first end thereof are connected to the damper portion by the connecting pin; and the deploying panels deploy in left-right symmetrical manner at the same speed about the fastening member so as to deploy in a balanced fashion. That is, since the deployment mechanism deploys both of the deploying panels simultaneously rather than one at a time, in comparison with a design having individually provided damper portions for applying damper force to the deploying panels, the deployment operation can take place smoothly without any time lag in deployment of the deploying panels, and the number of parts can be reduced.

A preferred embodiment of the present invention may employ a configuration wherein the camera support member is disposed upright at an end of the fastening member, a base portion to which the guide member fastens is provided, and the deploying panels stow in the base portion with their edges meeting.

Yet another preferred embodiment of the present invention may employ a configuration wherein the damper portion is connected to the connecting pin, and includes a damper body which has a pinion gear and which imparts resisting force to turning of the pinion gear; and a rack gear for rotating the pinion gear. Moreover, the damper portion may be constituted by a one-way damper which applies resistance force in one direction only, whereby the stowing operation can be carried out quickly.

Yet another preferred embodiment of the present invention may employ a configuration wherein the camera support member has engaging projections which with the deploying panels interfaced with respect to the base portion will engage the deploying panels (22R, 22L) and the base portion; and a lock mechanism capable of operation between a locked state in which the engaging projections engage the deploying panels and the base portion, and an unlocked state in which the engagement is released from the locked state. With this arrangement, the components can be switched from the locked state to the unlocked state through operation of the lock mechanism, and deployment of the deploying panels can take place automatically while at the same time utilizing the damper action of the damper portion.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a perspective view depicting a document presentation apparatus pertaining to an embodiment of the invention, shown deployed for service.

FIG. 2 is a side view depicting the document presentation apparatus shown deployed for service.

FIG. 3 is a perspective view depicting the document presentation apparatus in the stowed condition.

FIG. 4 is a perspective view depicting a video camera viewed from diagonally below.

FIG. 5 shows the deployment mechanism from the back side.

FIG. 6 is an exploded perspective view of the deployment mechanism.

FIG. 7 is a partly exploded perspective view of the vicinity of the lock mechanism.

FIG. 8 shows the lock mechanism.

FIG. 9 shows the deployment operation of the document presentation apparatus.

FIG. 10 shows the operation continuing from FIG. 9.

FIG. 11 shows the operation continuing from FIG. 10.

### DESCRIPTION OF THE PREFERRED EMBODIMENTS

(1) General Configuration of Presentation Apparatus 10

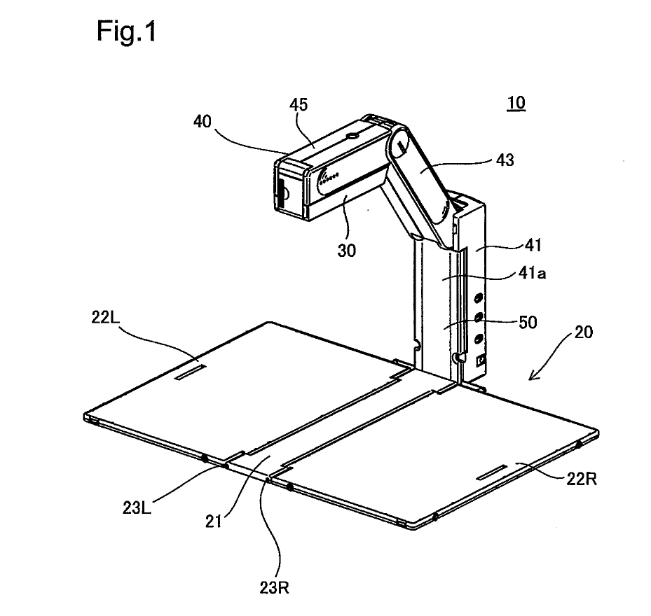

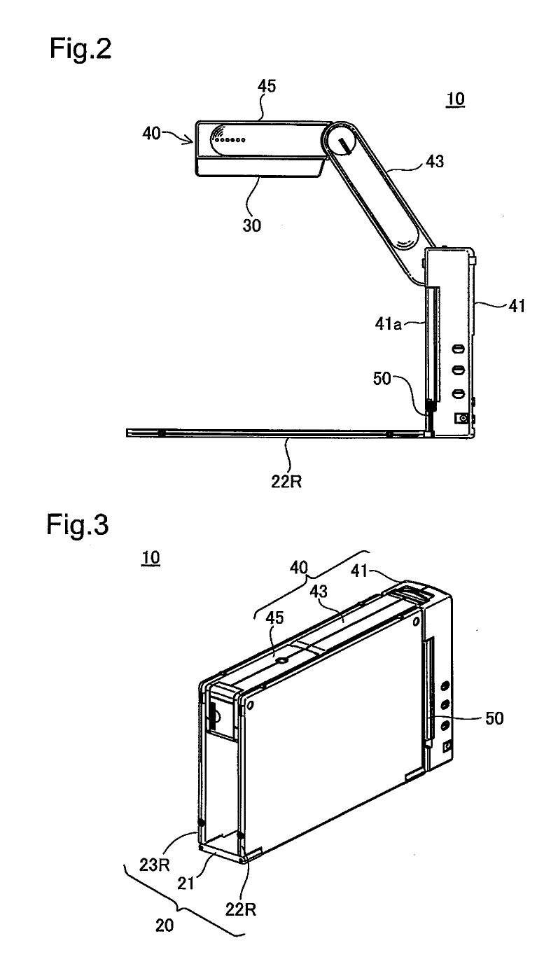

An imaging apparatus pertaining to the present invention will be described on the basis of a preferred embodiment. FIG. 1 is a perspective view depicting a presentation apparatus 10 pertaining to the embodiment shown deployed for service; FIG. 2 is a side view depicting the presentation apparatus 10 shown deployed for service; and FIG. 3 is a perspective view depicting the presentation apparatus 10 in the stowed condition. As shown in FIG. 1, the presentation apparatus 10 includes a table 20 having planar dimensions greater than those of A4 size paper; a camera support member 40 with a video camera 30 mounted at its distal end; and a deployment mechanism 50. By the configuration of the presentation apparatus 10, the table 20 may be deployed through the deployment mechanism 50 from the stowed condition of the presentation apparatus 10 illustrated in FIG. 3 to the condition for service illustrated in FIGS. 1 and 2; and an original document or the like may then be placed on the table 20, imaged by the video camera 30, and presented on a computer display. It is possible thereby to make a presentation in which the original placed on the table 20 is described while it is being presented on the display. The configuration and operation of the various parts of the presentation apparatus 10 will be discussed below.

(2) Configuration of Parts of Presentation Apparatus 10

### (2)-1 Table 20

The table 20 is composed of a fastening member 21 which is fastened to the lower end of the camera support member 40; and two deploying panels 22R, 22L which are pivotably supported at either side of the fastening member 21. The fastening member 21 and the deploying panels 22R, 22L are thin panels made of synthetic resin material; while not depicted in the drawings, metal plates, not shown, are attached to their back face for reinforcing purposes. The fastening member 21 is provided at both sides with slots which extend for prescribed length, into which tongue portions of the deploying panels 22R, 22L insert. Through-holes are provided in the mating portions of the two, and pivot shafts 23R, 23L are inserted into these so that the deploying panels 22R, 22L are pivotably disposed on the fastening member 21.

(2)-2 Video Camera 30 and Camera Support Member 40

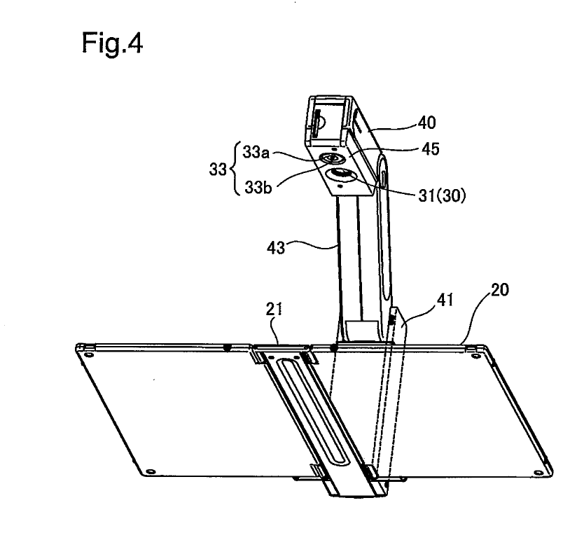

FIG. 4 is a perspective view depicting the video camera 30 viewed from diagonally below. The video camera 30 is installed on the lower face at the upper end of the camera support member 40. The camera support member 40 is composed of a base portion 41 which is connected to the fastening member 21; an arm portion 43 which is swivelably linked to the base portion 41; and a camera retaining member 45 which is swivelably linked to the arm portion 43 and to which the video camera 30 fastens. A detachable facing plate 41a as shown in FIG. 2 is attached to the base portion 41 on the side thereof lying towards the table 20; and in the interior of the base portion 41 there are housed the deployment mechanism 50, discussed later, electronic circuitry, and so on.

The video camera 30 is housed within the camera retaining member 45, with an imaging lens 31 of the video camera 30 positioned on the lower face of the camera retaining member 45. An illumination portion 33 is situated towards the distal end side of the camera retaining member 45 with respect to the imaging lens 31. The illumination portion 33 includes a lamp 33a consisting of a highly directional light source such as a light-emitting diode (LED); and a diffuser plate 33b for diffusing the light from the lamp 33a to produce uniform illumination over the entire surface of the table 20. The lamp 33a of the illumination portion 33 is lit to illuminate the entire surface of the table 20 via the diffuser plate 33, and the reflected light is captured by the video camera 30 which then outputs an external signal through an output terminal.

(2)-3 Deployment Mechanism 50

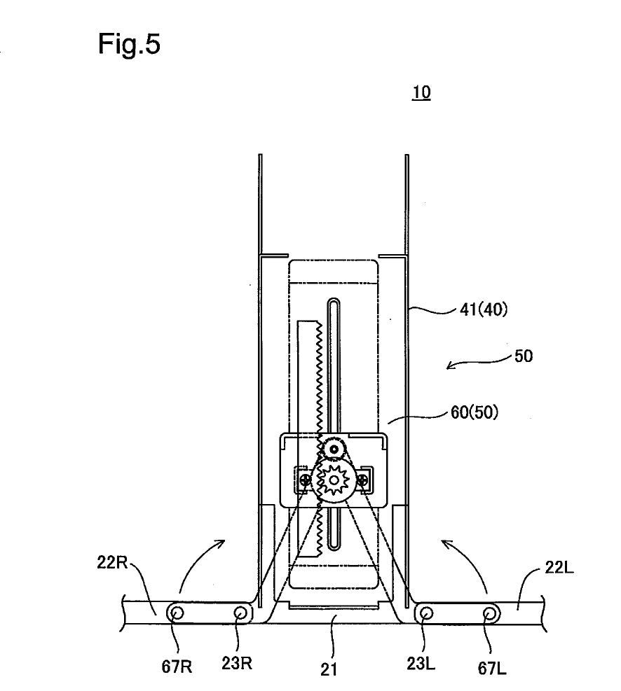

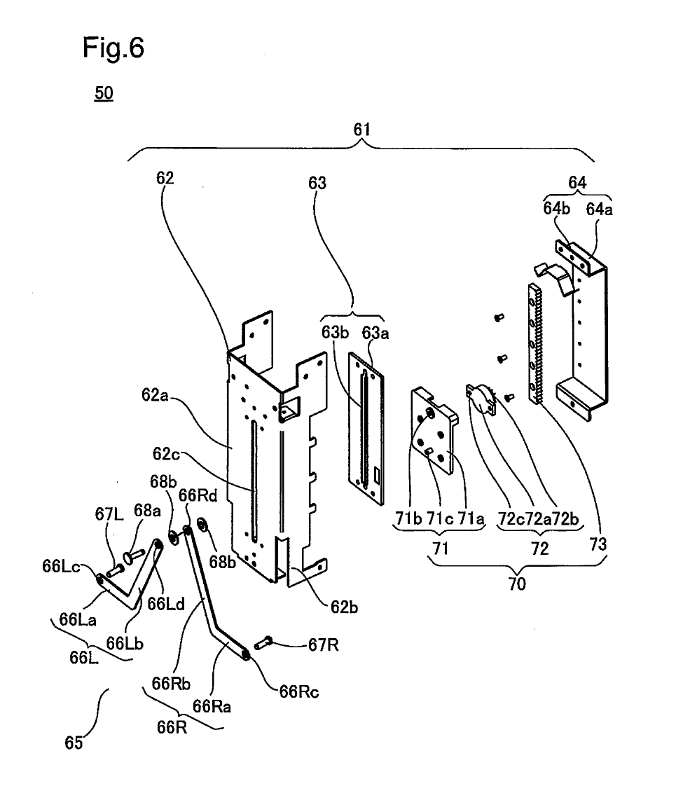

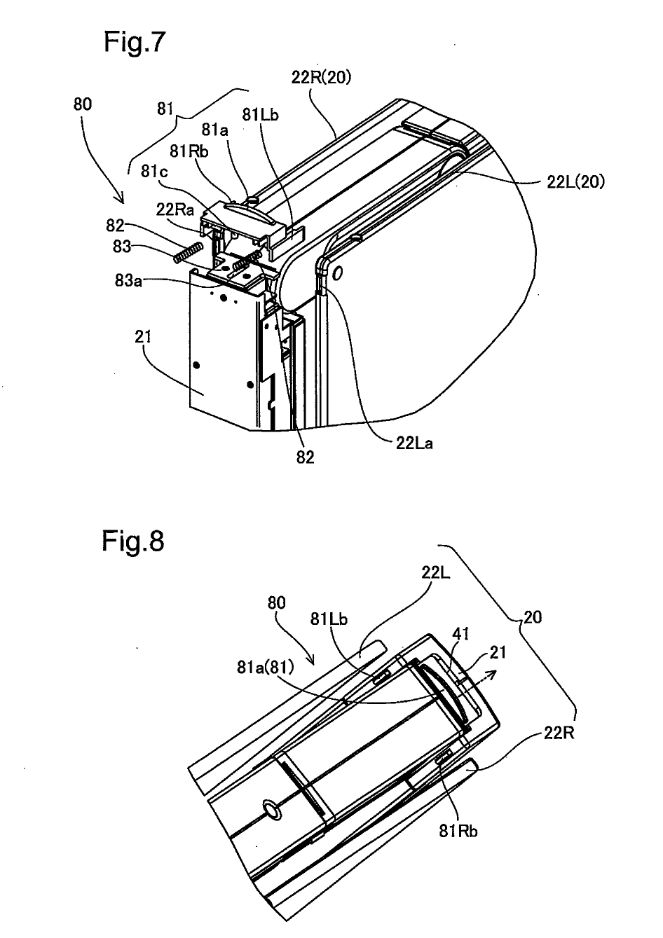

FIG. 5 is an illustration showing the deployment mechanism 50 from the back side; FIG. 6 is an exploded perspective view of the deployment mechanism 50; and FIG. 7 is a partly exploded perspective view of the upper part of the base portion 41. The deployment mechanism 50 is housed within a housing space in the base portion 41 shown in FIGS. 5 and 6; and includes a damper mechanism 60 for the purpose of slowing the speed at which the deploying panels 22R, 22L deploy from the fastening member 21, and a lock mechanism 80 for setting the deploying panels 22R, 22L to the locked state or unlocked state with respect to the camera support member 40 shown in FIG. 7. When switched from the locked state to the unlocked state through operation of the lock mechanism 80, the deploying panels 22R, 22L will slowly deploy from the fastening member 21 through the agency of the damper mechanism 60.

(a) Damper Mechanism 60

The damper mechanism 60 in FIG. 6 includes a support portion 61 which fastens to the base portion 41 (FIG. 1); a link mechanism 65; and a damper portion 70 for applying viscous resistance. The support portion 61 is fastened to the inner side of the base portion 41 and includes a support member 62, a guide plate 63, and a fastening member 64. The support portion 61 also has a front wall 62a and side walls 62b inflected from either edge of the front wall 62a; and is fastened at its side walls 62b to the inside walls of the base portion 41. In the front wall 62a there is formed a guide slot 62c extending in the vertical direction. The guide plate 63 is fastened to the front wall 62a of the support member 62, and includes a guide body 63a of plate form. In the guide body 63a is formed a guide slot 63b extending in the vertical direction and situated at a location coinciding with the guide slot 62c of the support member 62. The fastening member 64 includes a fastening body 64a and a mounting portion 64b which is inflected from the upper edge of the fastening body 64a, and via the mounting portion 64b is fastened to the support member 62 with screws.

The link mechanism 65 is a mechanism which connects the deploying panels 22R, 22L (FIG. 5) with the damper portion 70, and includes left-right symmetrical link members 66R, 66L. The link member 66R is a bar composed of a first link 66Ra and a second link 66Rb inflected in “V” shape, and is swivelably linked to the side of the deploying panel 22R (FIG. 5) via a swivel pin 67R at a through-hole 66Rc located at a first end of the first link 66Ra. The link member 66L is analogous in design to the link member 66R having a first link 66La and a second link 66Lb of “V” shape swivelably linked to the side of the deploying panel 22L (FIG. 5) via a swivel pin 67L which is passed through a through-hole 66Lc. Through-holes 66Rd, 66Ld are formed at the other ends of the link members 66R, 66L, and a connecting pin 68a is passed through these through-holes 66Rd, 66Ld. The connecting pin 68a also passes through the guide slot 62c of the support member 62 and the guide slot 63b of the guide plate 63 discussed earlier, and is connected to the damper portion 70 end. Washers 68b, 68b are interposed respectively between the link member 66R and the link member 66L, and between the link member 66L and the support member 62. Owing to the design of the link mechanism 65, the connecting pin 68a will ascend and descend through the guide slots 62c, 63b through the agency of the link members 66R, 66L, in association with the deploying panels 22R, 22L being swiveled with respect to the fastening member 21.

The damper portion 70 includes a slide member 71, a damper body 72, and a rack gear 73. The slide member 71 includes a plate-shape slide body 71a which is slidable in the vertical direction in combination with the guide plate 63. A screw hole 71b which threadably mates with the connecting pin 68a is formed in the slide body 71a; and a guide pin 71c which is guided by the guide slot 63b of the guide plate 63 is formed below the screw hole 71b. The damper body 72 includes a resistance portion 72a, and a pinion gear 72b which is pivotably supported on a shaft of the resistance portion 72a; and is fastened with screws to the slide member 71 via a mounting portion 72c. The rack gear 73 is fastened to the fastening member 64 so as to mesh with the pinion gear 72b. Owing to the design of this damper portion 70, as the slide member 71 is subjected to ascending or descending force by the connecting pin 68a and ascends or descends in unison with it, the pinion gear 72b of the damper body 72 will rotate along the rack gear 73; and in association with this the pinion gear 72b will be subjected to the viscous resistance of the resistance portion 72a and will apply resisting force to the ascending or descending movement of the slide member 71 and the link mechanism 65.

(b) Lock Mechanism 80

The lock mechanism 80 in FIG. 7 is a mechanism for placing the deploying panels 22R, 22L in the locked state or the unlocked state with respect to the base portion 41 as discussed earlier; it includes an operating portion 81, springs 82 for energizing the operating portion 81, and a guide portion 83 for guiding the operating portion 81. The operating portion 81 includes a push operation portion 81a which projects from its upper face; and engaging projections 81Rb, 81Lb which project from its side faces. The engaging projections 81Rb, 81Lb respectively enter and engage with or exit and disengage from engaging slots 22Ra, 22La which have been formed in the sides of the deploying panels 22R, 22L. A guide projection 81c is formed on the lower face of the operating portion 81, and is guided along a guide groove 83a of the guide portion 83. Owing to the design of the lock mechanism 80, when the push operation portion 81a of the operating portion 81 is operated and moved in the release direction, the operating portion 81 will slide in opposition to the spring force of the springs 82 while being guided by the guide portion 83, whereupon the engaging projections 81Rb, 81Lb will uncouple from the engaging slots 22Ra, 22La of the deploying panels 22R, 22L, thereby placing the deploying panels 22R, 22L in the unlocked state whereby they are releasable from the base portion 41. On the other hand, when the deploying panels 22R, 22L have been swiveled about the shafts 23R, 23L so as to interface with the base portion 41 as shown in FIG. 5, the side edges of the deploying panels 22R, 22L will push against the operating portion 81 shown in FIG. 7, pushing it inward in opposition to the spring force of the springs 82 so that the engaging projections 81Rb, 81Lb now engage the engaging slots 22Ra, 22La, thereby placing the deploying panels 22R, 22L in the locked state whereby they are unreleasable from the base portion 41.

(3) Deployment Operation and Stowage Operation of Deployment Mechanism 50

### (3)-1 Deployment Operation

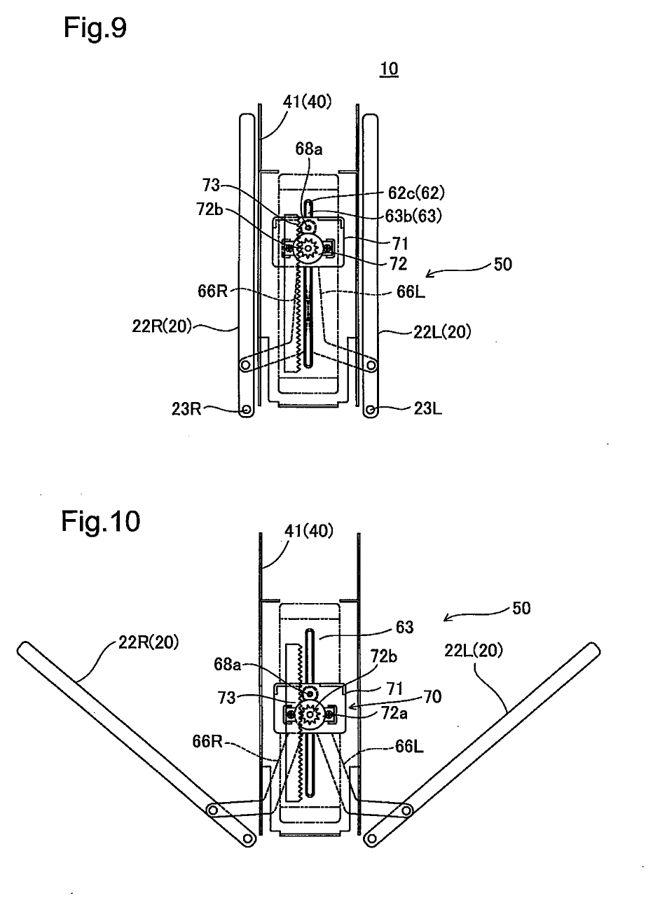

The following operation is carried out in order to take the presentation apparatus 10 from the stowed state to the service state. Let it be assumed that the presentation apparatus 10 is in the shut state with the deploying panels 22R, 22L of the table 20 placed against the camera support member 40 as shown in FIG. 9. In the state, when the push operation portion 81a of the lock mechanism 80 shown in FIG. 8 is pushed in the direction shown by the arrow, the operating portion 81 shown in FIG. 7 will move in opposition to the spring force of the springs 82 while being guided by the guide portion 83. The engaging projections 81Rb, 81Lb disposed on the operating portion 81 will respectively uncouple from the engaging slots 22Ra, 22La of the deploying panels 22R, 22L, unlocking the panels. Once unlocked, the deploying panels 22R, 22L will swivel under their own weight about the pivot shafts 23R, 23L as depicted in FIG. 9, pulling on the first end of each of the link members 66R, 66L.

Since the other ends of the link members 66R, 66L are connected to the connecting pin 68a, the connecting pin 68 will apply force which moves the slide member 71 downward, as the pin 68 moves along the guide slot 62c of the support member 62 and the guide slot 63b of the guide plate 63. As the slide member 71 is subjected to downward force, the pinion gear 72b of the damper body 72 which is fastened to the slide member 71 will rotate while meshing with rack gear 73. As shown in FIG. 10, the slide member 71 will move downward along the guide plate 63. At this point, in association with rotation of the pinion gear 72b, the resistance portion 72a which has been formed on the shaft of the pinion gear 72b will apply viscous resistance to rotation of the pinion gear 72b. This resisting force will be transmitted to the deploying panels 22R, 22L via the slide member 71, the connecting pin 68a, and the link members 66R, 66L. Specifically, while being subjected to the resisting force, the deploying panels 22R, 22L will open at a slow rate of speed under a reduced level of gravity-induced opening force, and come to a stop on the placement stage as shown in FIG. 1. The presentation apparatus 10 will thereby be placed in the service state depicted in FIG. 1.

(3)-2 Stowing Operation

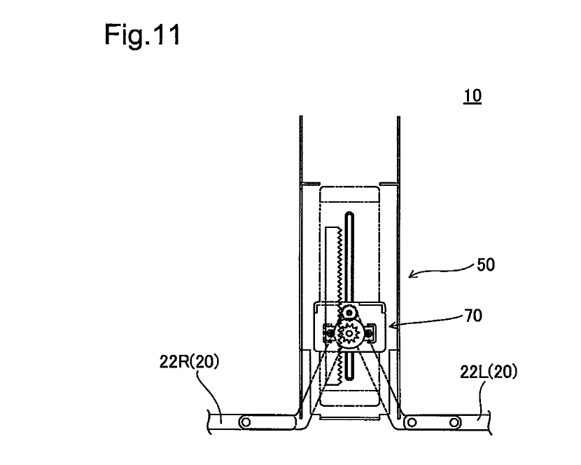

The following operation is carried out in order to place the presentation apparatus 10 in the stowed state from the service state to. Specifically, from the service state in FIG. 11, the deploying panels 22R, 22L are held at their two edges and swiveled towards the base portion 41 as shown in FIG. 10. Thereby, the ends of the link members 66R, 66L and the slide member 71 of the damper portion 70 will ascend in unison in cooperation with the deploying panels 22R, 22L. The pinion gear 72b will rotate along the rack gear 73 due to the ascent of the slide member 71. At this time, resisting force to the stowing operation of the deploying panels 22R, 22L will be created by the viscous resistance of the damper body 72. Then, with the deploying panels 22R, 22L positioned against the base portion 41, the engaging projections 81Rb, 81Lb of the lock mechanism 80 will engage the engaging slots 22Ra, 22La of the deploying panels 22R, 22L, thereby placing the lock mechanism in the locked state. The presentation apparatus 10 will thereby set the stowed state depicted in FIGS. 3 and 9.

(4) Working Effects of the Embodiment

The embodiment hereinabove affords the following working effects.

(4)-1 With the presentation apparatus 10 in the stowed state shown in FIGS. 3 and 9, by operating the lock mechanism 80 to release it from the locked state, the deploying panels 22R, 22L will deploy slowly through spontaneous descent while subjected to the resistance of the damper mechanism 60 via the link mechanism 65, so that the panels will deploy with an agreeably soft touch without striking noise or damage when coming into contact with the placement stage.

(4)-2 Since the two link members 66R, 66L are connected at a first end thereof to the damper portion 70 via the connecting pin 68a, and the deploying panels 22R, 22L deploy in left-right symmetrical manner at the same speed, they will deploy in a balanced fashion. That is, since the deployment mechanism 50 deploys both of the deploying panels 22R, 22L simultaneously rather than one at a time, in comparison with a design having individually provided damper portions for applying damper force to the deploying panels 22R, 22L, the deployment operation can take place smoothly with no time lags in deployment of the deploying panels 22R, 22L, and the number of parts can be reduced.

(4)-3 When returning the presentation apparatus 10 to the stowed state, as the edges of the deploying panels 22R, 22L are lifted up by hand the deployment mechanism 50 can shut slowly through the damper action of the damper mechanism 60, and the edge of the deploying panel 22R may bump against the base portion 41.

(4)-4 Since the deploying panels 22R, 22L are connected to one another at a first end and interlock with the damper portion 70, if one of the deploying panels 22R, 22L is closed the other will close simultaneously, thus affording excellent ease of operation.

(5) This invention is not limited by the particular embodiment disclosed herein and may be reduced to practice in various other ways without departing from the spirit thereof. For example, modifications such as the following would be possible.

(5)-1 The damper portion 70 in the preceding embodiment is designed to exert damping action in both the deployment and the stowage directions but is not limited to doing so. An arrangement employing a one-way clutch or the like in the damper portion to eliminate or reduce damper action in the stowage direction could be employed instead for faster stowing action.

(5)-2 While the damper portion herein is designed to apply resisting force through viscous resistance it is not limited to doing so, and other arrangements which exert resistance force, such as a spring, could be employed instead.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. An imaging apparatus comprising: a foldably stowed table for positioning of an imaging subject; a video camera imaging the imaging subject on the table; a camera support member for holding the video camera; and a deployment mechanism for deploying the folded table and for stowing the deployed table, wherein
the table includes: a fastening member fastening the camera support member; and deploying panels respectively pivotably supported at the sides of the fastening member, and
the deployment mechanism includes (i) link members having a first end and second end respectively, the first ends pivotably connected to the deploying panels respectively, the second ends connected to one another through a connecting pin, (ii) a guide member for guiding the movement of the connecting pin, and (iii) a damper portion for applying resistance to movement of the connecting pin.

2. The imaging apparatus in accordance with claim 1, wherein
the camera support member includes a base portion disposed upright at an end of the fastening member and fasten the guide member, the base portion being configured to stow and fit side walls of the deploying panels respectively.

3. The imaging apparatus in accordance with claim 2, wherein
the damper portion includes a damper body that is connected to the connecting pin, a pinion gear that connects with the damper body and a rack gear for turning the pinion gear, the turning of the pinion gear on the rack gear imparting resisting force to the damper body.

4. The imaging apparatus in accordance with claim 3, wherein
the damper portion is a one-way damper which applies resistance force in one direction only.

5. The imaging apparatus in accordance with claim 4, wherein
the camera support member includes a lock mechanism that has engaging projections engaging with an end of the deploying panels respectively in a state that the deploying panels fit the base portion, wherein
the lock mechanism is configured to have a locked state and unlock state, the lock state being a state that the engaging projections engage the deploying panels, and the unlock state being a state that the engaging projections disengage the deploying panels.
